(19) United States
(12) Patent Application Publication
(10) Pub. No.: US 2025/0010831 A1
(43) Pub. Date: Jan. 9, 2025

(54) Device for Generating a Fluidic Brake Control Signal

(71) Applicant: KNORR-BREMSE Systeme fuer Nutzfahrzeuge GmbH, Muenchen (DE)

(72) Inventor: Fabian GRIESSER, Muenchen (DE)

(21) Appl. No.: 18/711,179

(22) PCT Filed: Nov. 17, 2022
(86) PCT No.: PCT/EP2022/082227

§ 371 Date: May 17, 2024

(30) Foreign Application Priority Data
Nov. 19, 2021 (DE) 10 2021 213 039.9

(51) Int. Cl. B60T 13/68; B60T 8/172

(52) U.S. Cl. CPC B60T 13/68; B60T 8/172; B60T 2201/03; B60T 2270/402; B60T 2270/413

(57) ABSTRACT

A device for generating a fluidic brake control signal for a fluidic brake system of a first vehicle is disclosed. The device includes: a control input, which is configured to receive a brake request signal; a control unit which is configured to process the brake request signal; a pressure source which is configured to provide a supply pressure; an outlet terminal, which is configured to output the fluidic brake control signal into the brake system; and a valve unit which is configured to be controlled by the control unit in accordance with the brake request signal and to generate and transmit the fluidic brake control signal to the outlet terminal on the basis of the supply pressure in accordance with the control by the control unit.

### BACKGROUND AND SUMMARY

The present invention relates to a device for generating a fluidic brake control signal for a fluidic brake system of a first vehicle, a brake system having such a device, a vehicle, as well as a method.

The current development of brake systems in the commercial vehicle field has the result that pneumatic brake systems are replaced by electromechanical brake systems. In vehicles having an electromechanical brake system, there is the problem that a trailer having a conventional pneumatic brake system nevertheless can be coupled to the commercial vehicle. Such a trailer usually receives a pneumatic brake control signal which is generated in the towing vehicle in order to activate the pneumatic brake system of the trailer. Since no compressed air is present in a towing vehicle having an electromechanical brake system, it is necessary to provide a possibility of generating a pneumatic brake control signal and making it available to the pneumatic brake system of the trailer.

The problem underlying the invention can be further formulated by generally providing a possibility of generating a brake control signal for a fluidic brake system. Thereby, this brake system does not necessarily have to be provided in a trailer. It is also conceivable that the vehicle has both an electromechanical and a fluidic brake system.

The term “fluidic” is to be below understood to mean both “pneumatic” and “hydraulic”.

Therefore, it is the object of the present invention to solve this problem.

This object is solved by the subject-matters of the independent claims. Advantageous further developments are subject-matters of the dependent claims.

According to the invention, a device for generating a fluidic brake control signal for a fluidic brake system of a first vehicle is provided. The device comprises the following:
a control input, which is configured to receive a brake request signal;
a control unit, which is configured to process the brake request signal;
a pressure source, which is configured to provide a supply pressure;
an outlet terminal, which is configured to output the fluidic brake control signal into the brake system; and
a valve unit, which is configured to be controlled by the control unit in accordance with the brake request signal and to generate and transmit the fluidic brake control signal to the outlet terminal on the basis of the supply pressure in accordance with the control by the control unit.

The pressure source can comprise a connection for receiving pressure from an external source, such as a pressure reservoir, a compressor, or a pump. However, the pressure source can also comprise a pressure reservoir or a pressure generator itself, such as a compressor or a pump. The pressure source can serve in particular to provide a fluid which functions as a pressure transmission medium.

The control unit can be configured electrically or electronically, wherein it is in line connection with the control input. The control input can comprise one or more connections for receiving the brake request signal. In particular, it can be provided that individual connections of the control input are in line connection with individual control devices of the control unit.

A device is thus provided which is configured to generate a fluidic brake control signal from an electrical or electronic brake request signal.

Preferably, the valve unit comprises a first valve control circuit and a second valve control circuit. Thereby, the device is preferably configured to generate the fluidic brake control signal directly by the first valve control circuit and/or the second valve control circuit. In this way, a simple construction of the device is possible which requires no further parts. Alternatively, the first valve control circuit and the second valve control circuit are configured to generate a fluidic device control signal, wherein the device, in particular, the valve unit, is configured to generate the fluidic brake control signal in response to the fluidic device control signal. The device control signal can be processed, for example, by a relay valve in order to generate the fluidic brake control signal.

Preferably, when the first valve control circuit and the second valve control circuit are configured to generate a fluidic device control signal, the valve unit comprises a pressure-actuated control valve. The pressure-actuated control valve is then configured to generate the fluidic brake control signal in response to the fluidic device control signal. According to a preferred embodiment, the pressure-actuated control valve comprises a relay valve.

Preferably, the valve unit comprises at least one electrically actuatable valve which is provided to be controllable by the control unit. In particular, the first and/or the second valve control circuit can comprise at least one such valve. These can be configured as spring-reset solenoid valves which, when they are not actuated by the control unit, return to a rest position in which they are either closed (normally-closed-valve) or open (normally-open-valve).

Preferably, the valve unit is configured to generate the fluidic brake control signal such that a situation-dependent activation of the brake system is caused by the fluidic brake control signal, in particular, in order to brake the vehicle during driving operation. This corresponds in particular to a case of a service braking. Alternatively or additionally, the valve unit is configured to generate the fluidic brake control signal such that a permanent activation of the brake system is caused by the fluidic brake control signal, in particular, in order to hold the vehicle at a standstill. This corresponds in particular to a case of a parking braking.

In the case that the first valve control circuit and the second valve control circuit are configured to generate a fluidic device control signal, the following is preferably provided: preferably, the first valve control circuit is configured to generate a fluidic device control signal such that a situation-dependent activation of the brake system is caused by the fluidic brake control signal, in particular, in order to brake the vehicle during driving operation, in particular, corresponding to a case of a service braking. Alternatively or additionally, the second valve control circuit is configured to generate a fluidic device control signal such that a permanent activation of the brake system is caused by the fluidic brake control signal, in particular, in order to hold the vehicle at a standstill, in particular, corresponding to a case of a parking braking.

Preferably, the device, particularly the valve unit, comprises a replenishment valve which is configured to replenish pressure for the fluidic brake control signal, in particular, upon permanent activation of the brake system. When the device comprises the first valve control circuit and the second valve control circuit, the replenishment valve is preferably configured to replenish pressure for the device control signal. Alternatively or additionally, the replenishment valve is configured to release pressure for the fluidic brake control signal, in particular, upon no activation of the brake system. When the device comprises the first valve control circuit and the second valve control circuit, the replenishment valve is preferably configured to release pressure for the device control signal. According to a preferred embodiment, the second valve control circuit is configured for permanent activation of the brake system. That is, in this case, the replenishment takes place via the replenishment valve to the second valve control circuit. For replenishment, it can be provided, for example, that a connection from the pressure source to the valve unit, in particular, to the first and/or second valve control circuit, is established via the replenishment valve. Preferably, this connection is controlled by the control valve which generates the fluidic brake control signal. For release, it can be provided, for example, that a connection from the valve unit to the atmosphere, in particular, from the first and/or second valve control circuit to the atmosphere, is established via the replenishment valve. Preferably, this connection is controlled by the control valve which generates the fluidic brake control signal. Thereto, the control valve preferably comprises a venting connection.

Preferably, the control unit comprises a first control device and a second control device. The control devices are preferably configured to be redundant. In particular, it can be provided that the first control device assumes a control of a case of a service braking and the second control device assumes a control of a case of a parking braking, wherein, if the second control device is defective or, in general, a control via the second control device is not possible, a control of a case of a parking braking by the first control device is also possible. The first and/or second control device preferably comprise/comprises electrical or electronic control devices such as an electrical switch, a transistor, or an electronic controller.

In the case that the valve unit comprises a first valve control circuit and a second valve control circuit, the first control device is preferably configured to control the first valve control circuit and the second control device is preferably configured to control the second valve control circuit.

Preferably, the device comprises a connecting valve which is configured to connect the first valve control circuit and the second valve control circuit to each other and to separate them from each other, wherein the connecting valve is preferably controllable by the control unit, particularly preferably by the first control device. In this way, it is possible to feed pressure from one valve control circuit via the connecting valve to the other valve control circuit or to release pressure from one valve control circuit via the connecting valve and through the other valve control circuit. Preferably, the device is configured, in the case, of a connection of the first valve control circuit via the connecting valve to the second valve control circuit, to perform a generation of the fluidic device control signal in the first valve control circuit by the second valve control circuit and/or a generation of the fluidic device control signal in the second valve control circuit by the first valve control circuit. Thus, a redundant generation of the fluidic device control signal is possible. If, for example, the first valve control circuit is provided to generate the fluidic device control signal for performing a service braking and, at the same time, the second valve control circuit is provided to generate the fluidic device control signal for performing a parking braking, then, in the case of failure of the control possibility of the second valve control circuit, for example, if a corresponding control device is defective, the generation of the device control signal can take place by the first valve control circuit, which is fed via the connecting valve into the second valve control circuit. In this way, a parking braking functionality can also be implemented with the first valve control circuit which is actually provided primarily for implementing the service braking functionality. Alternatively or additionally, the reverse configuration of the device is also conceivable, i.e., a generation of the fluidic device control signal by the second valve control circuit is also possible, which is then sent via the connecting valve to the first valve control circuit.

Preferably, the brake request signal comprises exclusively at least one electrical or electronic signal. Alternatively or additionally, the device comprises exclusively the control input as the control input, as described above. That is, no further input signals, in particular, no fluidic input signals, are required in order to control the brake system by means of the device according to the invention.

Preferably, the device is configured to be modular. Alternatively or additionally, the device comprises a housing or a carrier element, which comprises the control input, the control unit, the pressure source, the outlet terminal and the valve unit as elements. A carrier element differs from a housing in that, with the exception of the outlet terminal, at least one of the elements is not encapsulated. The modular configuration has the advantage that the device can be installed and removed as a whole so that assembly and maintenance are significantly simplified.

Preferably, the device is configured to be attached in or on a second vehicle, wherein the second vehicle is coupled to the first vehicle. Specifically, the second vehicle is configured as a towing vehicle which tows the first vehicle which is configured as a trailer. However, it can also be provided that the brake system which is controlled by the device by means of the fluidic brake control signal and the device are provided on the same vehicle.

Subsequently, further subject-matters according to the invention are described. Features of these subject-matters which were mentioned in the above description of the device are to be understood as optional features of these subject-matters.

According to a further aspect of the invention, a brake system for a vehicle is provided, wherein the brake system comprises a device as described above. The brake system preferably comprises a part which is not fluidically actuated. In particular, this part can be electromechanically actuated. Further, the brake system comprises a fluidically actuated part, wherein the device is provided to receive a brake request signal, in particular, from the part which is not fluidically actuated, and to send a fluidic brake control signal to the fluidically actuated part.

According to a further aspect of the invention, a vehicle is provided, wherein the vehicle comprises a device as described above or a brake system as described above. The vehicle is preferably electrically driven and comprises, particularly for this purpose, a combination of an electrical drive machine with an electrical energy storage and/or a fuel cell. However, the vehicle can also be driven in a hybrid or conventional manner. Further, the vehicle can be a towing vehicle, a commercial vehicle, a combination of towing vehicle and trailer, a trailer, or a bus.

According to a further aspect of the invention, a method for generating a fluidic brake control signal for a fluidic brake system of a first vehicle is provided, the method comprising the following steps:
receiving a brake request signal;
generating a fluidic brake control signal in response to the brake request signal from a supply pressure by a valve unit; and
outputting the fluidic brake control signal, wherein

a device as described above is used for performing the method.

Subsequently, the invention is elucidated in more detail by means of preferred embodiments, wherein reference is made to the drawings.

### BRIEF DESCRIPTION OF THE DRAWINGS

FIG. 1: a device according to the invention according to a first embodiment;

FIG. 2: a device according to the invention according to a second embodiment; and

FIG. 3: a device according to the invention according to a third embodiment.

### DETAILED DESCRIPTION OF THE DRAWINGS

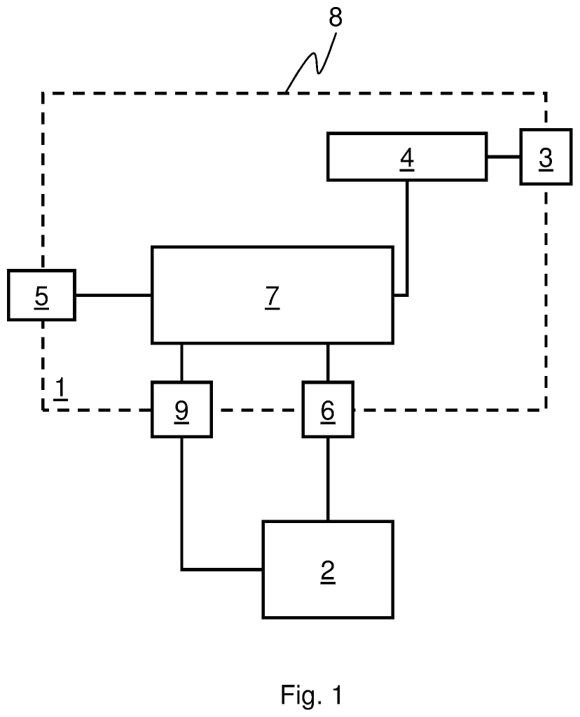

FIG. 1 shows a device according to the invention according to a first embodiment.

A device 1 which comprises a control input 3, a control unit 4, a pressure source 5, an outlet terminal 6, and a valve unit 7 is shown. The device 1 is connected via the outlet terminal 6 to a brake system 2 which can be controlled by means of a fluidic brake control signal which is sent via the outlet terminal 6 to the brake system 2.

The device 1 can receive a brake request signal via the control input 3. This can originate, for example, from a superordinate controller or from another brake system, such as an electromechanical brake system. The brake request signal eventually specifies a target value which corresponds to a desired degree of activation of the brake system 2, i.e., the target value contains, for example, information about the braking effect to be generated by the brake system 2. The brake request signal is received electrically or electronically via the control input 3 and it is converted by means of the device 1 into the fluidic brake control signal which is output via the outlet terminal 6.

For conversion, the device 1 comprises the control unit 4 which can comprise electrical and/or electronic control devices. The brake request signal is transmitted to the control unit 4, whereupon the control unit 4 controls the valve unit 7 in order to generate the fluidic brake control signal. For this purpose, the valve unit 7 comprises corresponding valves. For example, the valve unit 7 comprises solenoid valves which are controlled by the control unit 4.

The valve unit 7 is connected to the pressure source 5, by which, it receives a supply pressure. Further, the valve unit 7 is connected to the outlet terminal 6 in order to transmit the generated fluidic brake control signal to the brake system 2. Thereby, the valve unit 7 is configured to generate the fluidic brake control signal, which substantially represents a pressure signal, from the supply pressure.

The valve unit 7 is configured to generate the brake control signal for activating the brake system 2 during travel, wherein the valve unit 7 is further configured to also generate and hold a further brake control signal which permanently activates the brake system 2, whereby, for example, the vehicle can be held at a standstill.

The pressure source 5 can comprise a connection for receiving pressure from an external source. However, the pressure source 5 can also comprise a pressure reservoir or a pressure generator, such as a compressor or a pump.

Optionally, it is provided that the device comprises a housing 8 which comprises the above-described elements.

Optionally, it can further be provided that the device 1 comprises a supply terminal 9 which is configured to provide supply pressure from the pressure source 5 to the brake system 2. This supply terminal 9 is, as shown in the drawing, connected to the pressure source 5 via the interposed valve unit 7, so that a control of the connection from the pressure source 5 to the supply terminal 9 is controllable by the valve unit 7. However, it is also possible that a direct connection is provided between the pressure source 5 and the supply terminal 9, or that a connection is provided via other intermediate elements, such as, e.g., other valves which enable a control of this connection.

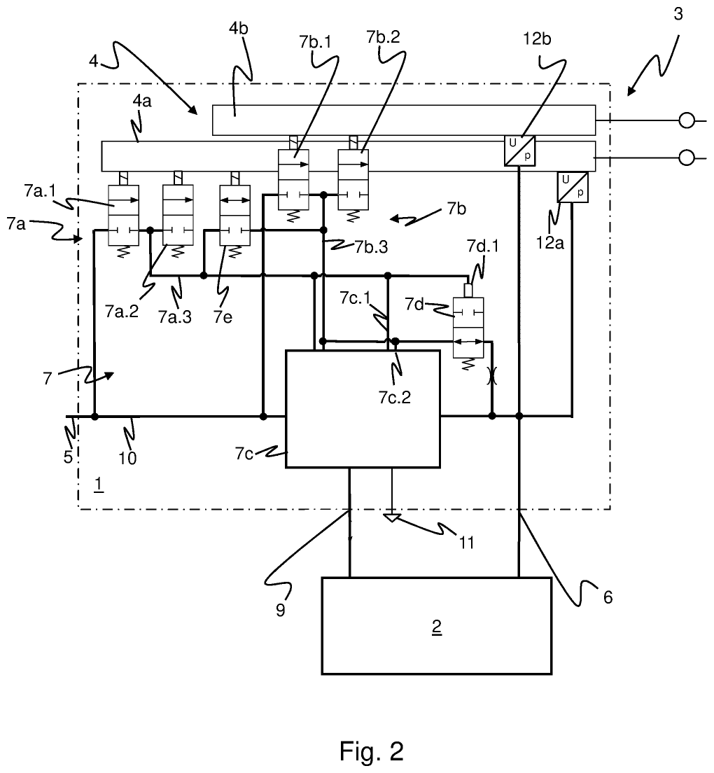

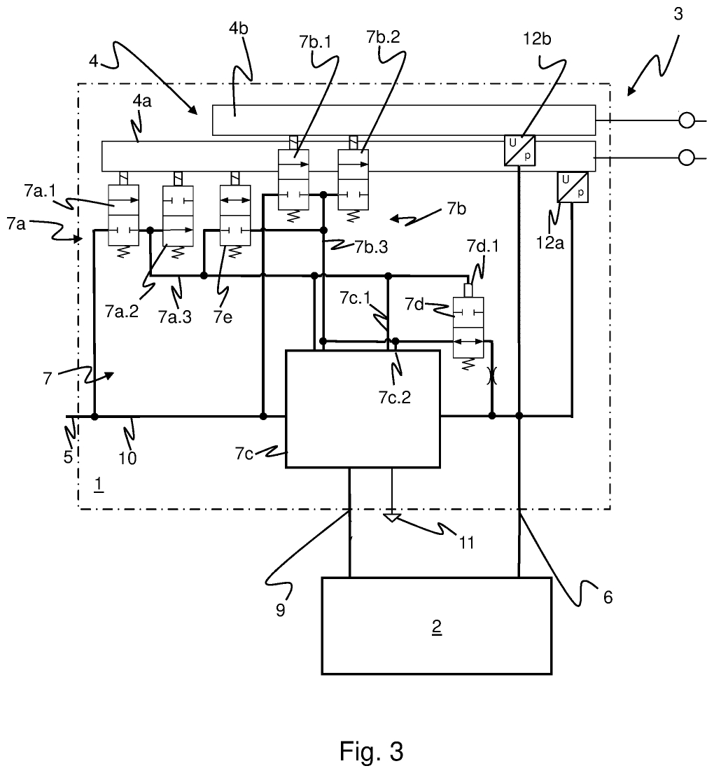

The subsequent embodiments according to FIGS. 2 and 3 represent more concrete embodiments of the general configuration of the invention as shown in FIG. 1.

FIG. 2 shows a device according to the invention according to a second embodiment. Since it is a more concrete description of an embodiment of the device 1 from FIG. 1, reference is also made to the description relating to FIG. 1, wherein the description relating to FIG. 2 acts in addition to this.

Here, the control input 3 is connected to a first control device 4a and a second control device 4b of the control unit 4. These control devices 4a, 4b can comprise electronic or electrical devices, for example, an electrical switch, a transistor, or an electronic controller. In the embodiment shown here, the control input 3 comprises two separate connections for the control devices 4a, 4b. However, other embodiments are also conceivable. For example, an individual connection can also be provided, which is in connection with both control devices 4a, 4b. The first control device 4a is connected to a first pressure sensor 12a, by which the first control device 4a receives information about the pressure at the outlet terminal 6. The second control device 4b is connected to a second pressure sensor 12b by which the second control device 4b receives information about the pressure at the outlet terminal 6. Alternatively, it can also be designated that a single pressure sensor is provided, the single pressure sensor providing information about the pressure at the outlet terminal 6 both to the first control device 4a and to the second control device 4b.

The valve device 7 comprises a first valve control circuit 7a. This control circuit 7a comprises an inlet valve 7a.1 and an outlet valve 7a.2 as well as a first valve control circuit line 7a.3. The first valve control circuit 7a is connected to the pressure source 5 via a supply line 10 so that supply pressure can be supplied to the first valve control circuit 7a. The inlet valve 7a.1 and the outlet valve 7a.2 are configured to adjust the pressure in the first valve control circuit line 7a.3, wherein they are configured as solenoid valves which are controlled by the first control device 4a of the control unit 4.

The valve device 7 comprises a second valve control circuit 7b. This control circuit 7b comprises an inlet valve 7b.1 and an outlet valve 7b.2 as well as a second valve control circuit line 7b.3. The second valve control circuit 7b is connected to the pressure source 5 via the supply line 10 so that supply pressure can be supplied to the second valve control circuit 7b. The inlet valve 7b.1 and the outlet valve 7b.2 are configured to adjust the pressure in the first valve control circuit line 7b.3, wherein, thereto, they are configured as solenoid valves which are controlled by the second control device 4b of the control unit 4.

The valve unit 7 further comprises a control valve 7c. This control valve 7c is connected to the pressure source 5 via the supply line 10 so that the control valve 7c can be supplied with supply pressure. The control valve 7c comprises a first control input 7c.1 and a second control input 7c.2. The first control input 7c.1 is connected to the first valve control circuit line 7a.3 and the second control input 7c.2 is connected to the second valve control circuit line 7b.3 so that each of the valve control circuits 7a, 7b can supply a fluidic device control signal to the control valve 7c. The control valve 7c is configured to generate a corresponding fluidic brake control signal from the supply pressure in response to a fluidic control signal which is sent to the first control input 7c.1 or to the second control input 7c.2. Further, the control valve 7c is connected to a venting connection 11.

The two valve control circuits 7a, 7b, more precisely the first valve control circuit line 7a.3 and the second valve control circuit line 7b.3, are in connection with a connecting valve 7e. This connecting valve 7e comprises a solenoid valve which can be controlled by the first control device 4a and via which the first valve control circuit line 7a.3 and the second valve control circuit line 7b.3 can be connected to each other and separated from each other.

Finally, the valve device 7 comprises a replenishment valve 7d. This replenishment valve 7d is configured as a pressure-actuated valve, wherein it comprises a replenishment control input 7d.1 which is connected to the first valve control circuit line 7a.3 so that the replenishment valve 7d is controllable depending on the pressure in the valve control circuit line 7a.3. The replenishment valve is configured to connect the second valve control circuit line 7b.3 to the pressure source 5 via the control valve 7c in order to replenish pressure into the second valve control circuit line 7b.3 when a pressure drop occurs there due to leakage which can have the result that the permanently activated brake system 2 is released. The replenishment takes place, as shown in the drawing, via a throttle. Further, it is provided that the valve control circuit line 7b.3 is connected to the atmosphere via the replenishment valve 7d and to the control valve 7c via the venting connection 11 in order to prevent an undesired filling of the valve control circuit line 7b.3, for example, due to leakage. Thereby, the control valve 7c is configured to selectively perform the connection of the replenishment valve 7d to the pressure source 5 or to the atmosphere.

The functioning of the device 1 is represented as follows.

In the shown position, the first valve control circuit line 7a.3 and the second valve control circuit line 7b.3 are pressureless. The inlet valves 7a.1, 7b.1 block the first valve control circuit 7a or the second valve control circuit 7b against the supply line 10. The connecting valve 7e is closed so that the first valve control circuit line 7a.3 and the second valve control circuit line 7b.3 are separated from each other. The replenishment valve 7d is in the transmission position, i.e., it allows a replenishment of pressure into the second valve control circuit line 7b.3.

If the vehicle is in a driving state and is to be braked, i.e., the brakes of the brake system 2 are not to be permanently activated, a control of the first valve control circuit 7a is performed in that the first control device 4a controls the inlet valve 7a.1 of the first valve control circuit 7a in accordance with a brake request signal which was received via the control input 3 and thereby it establishes a connection of the supply line 10 to the first valve control circuit line 7a.3. As a result, the pressure in the first valve control circuit line 7a.3 which acts as a device control signal on the first control input 7c.1 of the control valve 7c and on the replenishment control input 7d.1 of the replenishment valve 7d increases. As a result, the control valve 7c reacts and provides a corresponding pressure for the outlet terminal 6, which it generates from the supply pressure of the supply line 10. At the same time, the replenishment valve 7d changes from its shown first switching position into the second switching position in which it disconnects the second valve control circuit line 7b.3 from the replenishment, whereby it is prevented that an opposite control by the second valve control circuit line 7b.3 starts and thus reduces the control quality of the first valve control circuit 7a and of the first control device 4a. Thus, the brake system 2 can be controlled by the first control device 4a and the first valve control circuit 7a in a case of a service braking. A release or reduction of the activation of the brake system 2 can be performed by the outlet valve 7a.2 of the first valve control circuit 7a in that the first control unit 4a switches the outlet valve 7a.2 from the shown switching position into its second switching position in which it connects the first valve control circuit line 7a.3 to the atmosphere and thus vents the first valve control circuit line 7a.3.

If the vehicle is, for example, at a standstill and is to be permanently held therein by permanently activating the brakes of the brake system 2, a control of the second valve control circuit 7b is performed in that the second control device 4b controls the inlet valve 7b.1 of the second valve control circuit 7b in accordance with a brake request signal which was received via the control input 3 and, thereby, it establishes a connection of the supply line 10 to the second valve control circuit line 7b.3. As a result, the pressure in the second valve control circuit line 7b.3 which acts as a device control signal on the second control input 7c.2 of the control valve 7c increases. As a result, the control valve 7c reacts and provides a corresponding pressure for the outlet terminal 6, which it generates from the supply pressure of the supply line 10. At the same time, the replenishment valve 7d remains in its shown first switching position in which it connects the second valve control circuit line 7b.3 to the replenishment, whereby a replenishment is implemented which compensates for leakages in the second valve control circuit line 7b.3 so that a release of the permanently activated brake system 2 is prevented. Thus, the brake system 2 can be controlled by the second control device 4b and the second valve control circuit 7b in a case of a parking braking. A release or reduction of the activation of the brake system 2 can be performed by the outlet valve 7b.2 of the second valve control circuit 7b in that the second control unit 4b switches the outlet valve 7b.2 from the shown switching position into its second switching position in which it connects the second valve control circuit line 7b.3 to the atmosphere and thus vents the second valve control circuit line 7b.3.

Thus, as described above, it is possible to implement a service braking function by the first control device 4a and a parking braking function by the second control device 4b.

Furthermore, a redundancy function is provided which relates to a failure of the parking braking function by a fault of the second control device 4b and/or the second valve control circuit 7b.

For this case, a connection of the second valve control circuit line 7b.3 to the first valve control circuit line 7a.3 can be achieved in that the first control device 4a switches the connecting valve 7e from its shown switching position into its second switching position in which it connects the first valve control circuit line 7a.3 and the second valve control circuit line 7b.3 to each other. At the same time, the inlet valve 7a.1 of the first valve control circuit 7a is opened so that supply pressure is supplied from the supply line 10 into the first valve control circuit line 7a.3 and via the connecting valve 7e into the second valve control circuit line 7b.3. As a result, a device control signal is sent to the first control input 7c.1 and to the second control input 7c.2 of the control valve 7c and to the replenishment control input 7d.1 of the replenishment valve 7d. As a result, the replenishment valve 7d blocks the second valve control circuit line 7b.3 from the replenishment and allows a pressure build-up in the second valve control circuit line 7b.3. At the same time, the control valve 7c provides the corresponding fluidic brake control signal to the outlet terminal 6 in response to the pressure increase at the control inputs 7c.1 and 7c.2.

In order to permanently maintain this state and, in particular, to reactivate the replenishment by the replenishment valve 7d, as soon as the desired activation of the brake system 2 has been achieved, it is proceeded as follows.

The connecting valve 7e is switched back again into its switching position shown in the drawing, in which it separates the first valve control circuit line 7a.3 from the second valve control circuit line 7b.3. Since the inlet valve 7b.1 and the outlet valve 7b.2 of the second valve control circuit 7b are still closed, the previously fed pressure in the second valve control circuit line 7b.3 is maintained and acts on the second control input 7c.2 of the control valve 7c so that the fluidic brake control signal is permanently generated by the control valve 7c.

In order to reactivate the replenishment, the outlet valve 7a.2 of the first valve control circuit 7a is opened, i.e., the first valve control circuit line 7a.3 is vented to the atmosphere. As a result, no pressure acts on the replenishment control input 7d.1 anymore so that the replenishment valve 7d returns into the switching position shown in the drawing in which it connects the second valve control circuit line 7b.3 to the replenishment, whereby leakages are compensated for.

Thus, in the redundancy case, the second valve control circuit line 7b.3 is filled by the first valve control circuit line 7a.3 via the connecting valve 7e, wherein, subsequently, the pressure in the second valve control circuit line 7b.3 is maintained in that the connecting valve 7e separates the first valve control circuit line 7a.3 from the second valve control circuit line 7b.3 again.

A release of this state is performed by corresponding control of the connecting valve 7e and of the outlet valve 7a.1 of the first valve control circuit 7a in that the second valve control circuit line 7b.3 is connected to the first valve control circuit line 7a.3 and the second valve control circuit line 7b.3 is further vented to the atmosphere via the outlet valve 7a.1 of the first valve control circuit 7a.

The valves 7a.1, 7a.2, 7b.1, 7b.2 of the first and second valve control circuits 7a, 7b shown here are configured as spring-reset solenoid valves. That is, they switch back into the shown switching positions in the absence of control by the first and second control devices 4a, 4b. Their switching state without control is thus the closed state (so-called normally-closed-valves). However, embodiments in which one or more of these valves change into an open position without control (so-called normally-open-valves) are also conceivable.

FIG. 3 shows a device according to the invention according to a third embodiment, in which the outlet valve 7a.2 of the first valve control circuit 7a is configured as a normally-open-valve. In this case, the first valve control circuit line 7a.3 is permanently vented and it has to be closed against the atmosphere by active switching of the outlet valve 7a.2 in order to be able to fill it via the inlet valve 7a.1.

### LIST OF REFERENCE SIGNS

1 device
2 brake system
3 control input
4 control unit
4a first control device
4b second control device
5 pressure source
6 outlet terminal
7 valve unit
7a first valve control circuit
7a.1 inlet valve
7a.2 outlet valve
7a.3 first valve control circuit line
7b second valve control circuit
7b.1 inlet valve
7b.2 outlet valve
7b.3 second valve control circuit line
7c control valve
7c.1 first control input
7c.2 second control input
7d replenishment valve
7d.1 replenishment control input
7e connecting valve
8 housing
9 supply terminal
10 supply line
11 venting connection
12a first pressure sensor
12b second pressure sensor

1.-15. (canceled)

16. A device for generating a fluidic brake control signal for a fluidic brake system of a first vehicle, comprising:
a control input, which is configured to receive a brake request signal;
a control unit, which is configured to process the brake request signal;
a pressure source, which is configured for providing a supply pressure;
an outlet terminal, which is configured to output the fluidic brake control signal into the brake system; and
a valve unit, which is configured to be controlled by the control unit in accordance with the brake request signal and to generate and transmit the fluidic brake control signal to the outlet terminal based on the supply pressure in accordance with the control by the control unit.

17. The device according to claim 16, wherein
the valve unit comprises a first valve control circuit and a second valve control circuit, and
(i) the device is configured to generate the fluidic brake control signal directly by the first valve control circuit and/or by the second valve control circuit, or
(ii) the first valve control circuit and the second valve control circuit are configured to generate a fluidic device control signal, and the device is configured to generate the fluidic brake control signal in response to the fluidic device control signal.

18. The device according to claim 17, wherein
when the first valve control circuit and the second valve control circuit are configured to generate a fluidic device control signal, the valve unit comprises a pressure-actuated control valve, wherein
the pressure-actuated control valve is configured to generate the fluidic brake control signal in response to the fluidic device control signal.

19. The device according to claim 18, wherein
the pressure-actuated control valve comprises a relay valve.

20. The device according to claim 16, wherein
the valve unit comprises at least one electrically actuatable valve which is provided to be controllable by the control unit.

21. The device according to claim 16, wherein at least one of:
(i) the valve unit is configured to generate the fluidic brake control signal such that a situation-dependent activation of the brake system is caused by the fluidic brake control signal in order to brake the vehicle during driving operation, or
(ii) the valve unit is configured to generate the fluidic brake control signal such that a permanent activation of the brake system is caused by the fluidic brake control signal in order to hold the vehicle at a standstill.

22. The device according to claim 17, wherein at least one of:
(i) when the first valve control circuit and the second valve control circuit are configured to generate a fluidic device control signal, the first valve control circuit is configured to generate a fluidic device control signal such that a situation-dependent activation of the brake system by the fluidic brake control signal is caused in order to brake the vehicle during driving operation, or
(ii) when the first valve control circuit and the second valve control circuit are configured to generate a fluidic device control signal, the second valve control circuit is configured to generate a fluidic device control signal such that a permanent activation of the brake system by the fluidic brake control signal is caused in order to hold the vehicle at a standstill.

23. The device according to claim 22, further comprising:
a replenishment valve which:
(i) upon permanent activation of the brake system, is configured to replenish pressure for the fluidic brake control signal and/or to replenish pressure for the fluidic device control signal when the device comprises the first valve control circuit and the second valve control circuit, and/or
(ii) upon no activation of the brake system, is configured to release pressure for the fluidic brake control signal and/or to release pressure for the fluidic device control signal when the device comprises the first valve control circuit and the second valve control circuit.

24. The device according to claim 21, further comprising:
a replenishment valve which:
(i) upon permanent activation of the brake system, is configured to replenish pressure for the fluidic brake control signal and/or to replenish pressure for the fluidic device control signal when the device comprises the first valve control circuit and the second valve control circuit, and/or
(ii) upon no activation of the brake system, is configured to release pressure for the fluidic brake control signal and/or to release pressure for the fluidic device control signal when the device comprises the first valve control circuit and the second valve control circuit.

25. The device according to claim 16, wherein
the control unit comprises a first control device and a second control device, and
the first and second control devices are configured to be redundant.

26. The device according to claim 25, wherein
when the valve unit comprises a first valve control circuit and a second valve control circuit, the first control device is configured to control the first valve control circuit and the second control device is configured to control the second valve control circuit.

27. The device according to claim 17, further comprising:
a connecting valve which is configured to connect the first valve control circuit and the second valve control circuit to each other and to separate them from each other, wherein
the connecting valve is controllable by the control unit, such that in the case of a connection of the first valve control circuit via the connecting valve to the second valve control circuit, a generation of the fluidic device control signal in the first valve control circuit by the second valve control circuit and/or a generation of the fluidic device control signal in the second valve control circuit by the first valve control circuit is performed.

28. The device according to claim 16, wherein
the brake request signal comprises exclusively at least one electrical or electronic signal, and/or
the device comprises exclusively the control input as the control input.

29. The device according to claim 16, wherein at least one of:
(i) the device is configured to be modular and/or comprises a housing or a carrier element, which comprises the control input, the control unit, the pressure source, the outlet terminal and the valve unit as elements, or
(ii) the device is configured to be attached in or on a second vehicle, wherein the second vehicle is coupled to the first vehicle.

30. A brake system for a vehicle comprising a device according to claim 16.

31. A vehicle comprising a brake system according to claim 30.

32. A method for generating a fluidic brake control signal for a fluidic brake system of a first vehicle by use of the device according to claim 16, the method comprising the steps of:
receiving the brake request signal;
generating the fluidic brake control signal in response to the brake request signal from the supply pressure by the valve unit; and
outputting the fluidic brake control signal.
